(19) United States
(12) Patent Application Publication
(10) Pub. No.: US 2014/0179169 A1
(43) Pub. Date: Jun. 26, 2014

(54) MOUNTING APPARATUS FOR MEMORY CARD

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: KAI WU, Shenzhen (CN); YU HAN, Shenzhen (CN); XIAO-QING YI, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/897,437

(22) Filed: May 19, 2013

(30) Foreign Application Priority Data
Dec. 26, 2012 (CN) 2012105739044

(51) Int. Cl. H01R 12/72

(52) U.S. Cl. CPC H01R 12/721
USPC 439/630

(57) ABSTRACT

A mounting apparatus includes a socket, a first fixing member, and a second fixing member. The socket includes a main body for connecting a memory card, and two latches rotatably connected to opposite ends of the main body, for engaging with opposite ends of the memory card. Each of the first and second fixing members includes a housing and a locking portion rotatably connected to an end of the housing. The locking portions of the first and second fixing members latch with the latches of the socket. The housings of the first and second fixing members engage with each other and cover opposite ends of the top of the memory card.

### BACKGROUND

1. Technical Field

The present disclosure relates to an apparatus for fixing a memory card.

2. Description of Related Art

A memory card is often inserted into a socket on a motherboard without fixing structures. As a result, the memory card may loosen from vibrations during testing or transportation, which is undesirable.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of an embodiment of a mounting apparatus, together with a memory card.

FIG. 2 is an assembled, isometric view of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

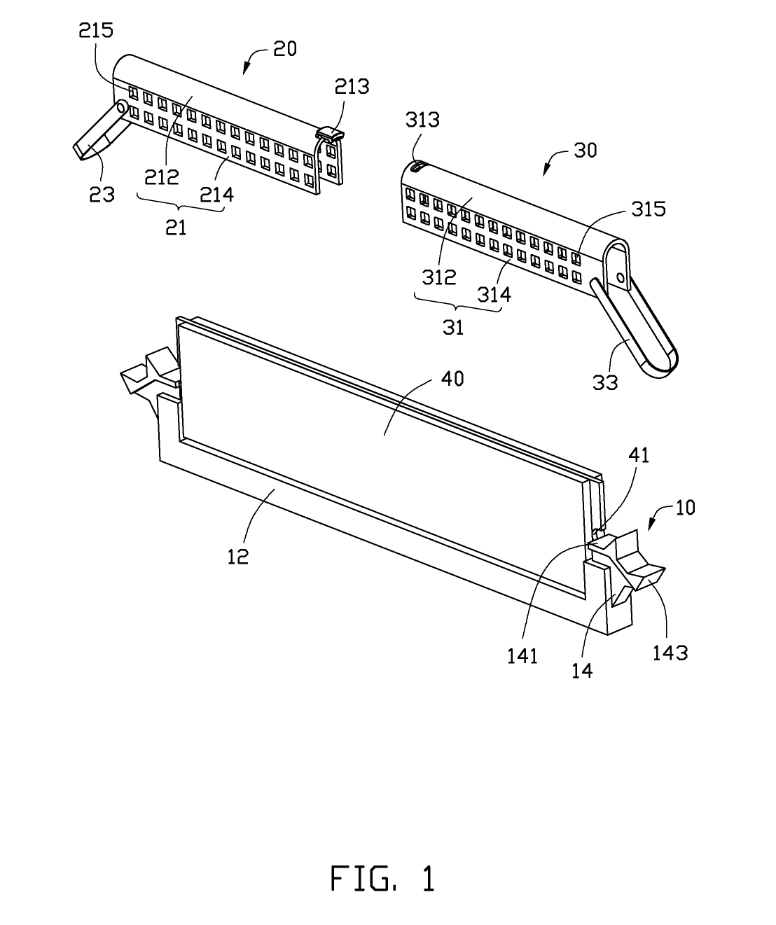

Referring to FIG. 1, an embodiment of a mounting apparatus is provided for fixing a memory card 40. The mounting apparatus includes a socket 10, a first fixing member 20, and a second fixing member 30.

The memory card 40 defines a cutout 41 in each of opposite ends.

The socket 10 includes a main body 12 to electrically receive the memory card 40 and two latches 14 pivotably mounted to opposite ends of the main body 12. Each latch 14 includes an engaging portion 141 extending toward the other latch 14, and an operation portion 143 extending away from the other latch 14.

The first fixing member 20 includes a substantially U-shaped housing 21 and a locking portion 23. The housing 21 includes a top wall 212 and two sidewalls 214 extending down from opposite sides of the top wall 212. An L-shaped hook 213 extends from an end of the top wall 212. Each sidewall 214 defines a plurality of vents 215. The locking portion 23 is U-shaped, and includes two distal ends pivotably connected to ends of the sidewalls 214 away from the hook 213.

The second fixing member 30 includes a substantially U-shaped housing 31 and a locking portion 33. The housing 31 includes a top wall 312 and two sidewalls 314 extending down from opposite sides of the top wall 312. A recess 313 is defined in an end of the top wall 312. Each sidewall 314 defines a plurality of vents 315. The locking portion 33 is U-shaped, and includes two distal ends pivotably connected to ends of the sidewalls 314 away from the recess 313.

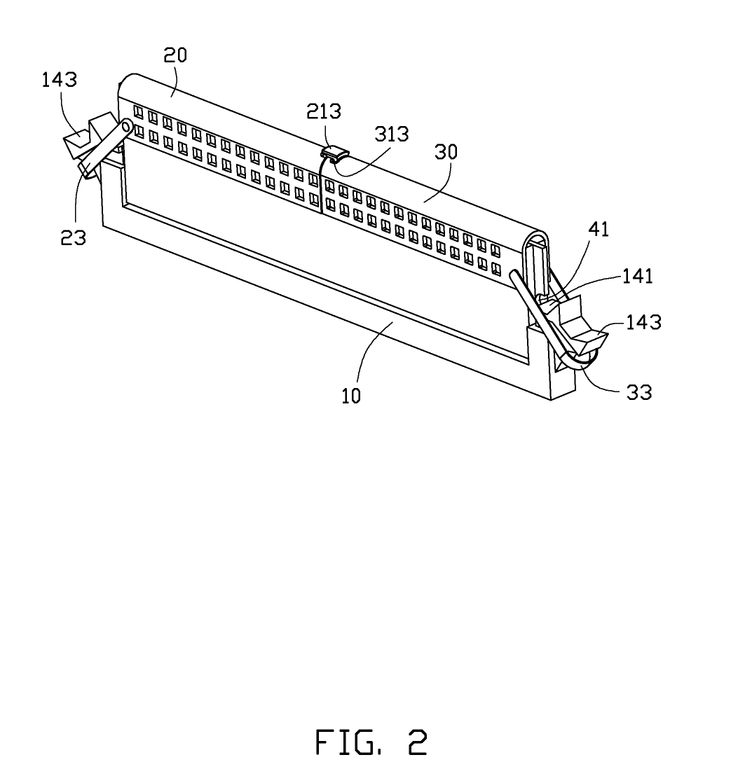

Referring to FIG. 2, in assembly, the memory card 40 is inserted into the main body 12. The latches 14 are pivoted toward each other, to allow the engaging portions 141 to engage in the cutouts 41. The locking portions 33 are fitted about the operation portions 143, with blind ends of the locking portions 33 away from the corresponding housings 21 and 31 positioned under the corresponding operation portions 143. The housings 21 and 31 are then mounted to a top of the memory card 40, with the sidewalls 314 positioned at opposite sides of the memory card 40. The housings 21 and 31 are then slid toward each other to allow the hook 213 to engage in the recess 313; thereby, tightly fixing the memory card 40 in the socket 10. Air may flow through the vents 215 to dissipate heat generated by the memory card 40.

In uninstalling the memory card 40, the housing 21 is slid toward the housing 31 and then is moved up, to disengage the hook 213 from the recess 313. The memory card 40 is then ready to be disengaged from the socket 10.

It is believed that the present embodiments and their advantages will be understood from the foregoing description, and various changes may be made thereto without departing from the spirit and scope of the description or sacrificing all of their material advantages, the examples hereinbefore described merely being exemplary embodiments.

What is claimed is:

1. A mounting apparatus for a memory card, comprising:
a socket comprising a main body to electrically receive the memory card, and two latches pivotably connected to opposite ends of the main body;
a first fixing member; and
a second fixing member;
wherein the first and the second fixing members each comprise a housing and a locking portion pivotably connected to a first end of the housing; in mounting the memory card, the housings are mounted to a top of the memory card and latch with each other, and the locking portions of the first and second fixing members are latched with the latches while the latches engage with the memory card.

2. The mounting apparatus of claim 1, wherein the second fixing member defines a recess in a second end of the second fixing member adjacent to the first fixing member, a hook extends out from a second end of the first fixing member adjacent to the second fixing member to be engaged in the recess.

3. The mounting apparatus of claim 1, wherein each latch comprises an operation portion extending away from the other latch; the locking portions are fitted about the operation portions.

4. The mounting apparatus of claim 3, wherein each locking portion is U-shaped, an end of each locking portion away from the corresponding housing is positioned under the corresponding operation portion.

5. The mounting apparatus of claim 1, wherein each housing is U-shaped and comprises a top wall and two sidewalls extending down from opposite sides of the top wall, the locking portions each comprise two distal ends pivotably mounted to the sidewalls of a corresponding one of the first and second fixing members.

6. The mounting apparatus of claim 5, wherein each sidewall defines a plurality of vents.

7. The mounting apparatus of claim 1, wherein each latch comprises an engaging portion extending toward the other latch to engage in the memory card.

8. A mounting apparatus for a memory card, comprising:
a socket comprising a main body to electrically connect the memory card, and two latches pivotably connected to opposite ends of the main body; and
first and second fixing members, each of the first and the second fixing members comprising a housing and a locking portion, the housing of the first and second fixing members fitted about opposite ends of an upper portion of the memory card opposite to the socket, the locking portion of each of the first and second fixing members pivotably connected to an end of the housing opposite to the other one of the first and second fixing members;
wherein the locking portions of the first and second fixing members detachably hook the latches.

9. The mounting apparatus of claim 8, wherein the second fixing member defines a recess in an opposite end of the second fixing member adjacent to the first fixing member, a hook extends out from an opposite end of the first fixing member adjacent to the second fixing member to be detachably engaged in the recess.

10. The mounting apparatus of claim 8, wherein each latch comprises an operation portion extending away from the other latch; the locking portions detachably hook the operation portions.

11. The mounting apparatus of claim 10, wherein each locking portion is U-shaped, distal ends of the locking portion are pivotably mounted to the housing, a blind end of each locking portion is engaged with a bottom of the corresponding operation portion.

12. The mounting apparatus of claim 8, wherein each housing is U-shaped and comprises a top wall and two sidewalls extending down from opposite sides of the top wall, the locking portions each are U-shaped, and comprise two distal ends pivotably mounted to the sidewalls of a corresponding one of the first and second fixing members.

13. The mounting apparatus of claim 12, wherein each sidewall defines a plurality of vents.

14. The mounting apparatus of claim 8, wherein each latch comprises an engaging portion extending toward the other latch to engage in the memory card.
